(19) United States
(12) Patent Application Publication
(10) Pub. No.: US 2016/0075006 A1
(43) Pub. Date: Mar. 17, 2016

(54) OIL SHIELD

(71) Applicant: Jeffrey L. Horgan, Richfield, UT (US)

(72) Inventor: Jeffrey L. Horgan, Richfield, UT (US)

(21) Appl. No.: 14/484,147

(22) Filed: Sep. 11, 2014

(51) Int. Cl. B25B 27/00; B25B 23/00; F01M 11/04

(52) U.S. Cl. CPC B25B 27/0042; F01M 11/0458; B25B 23/00

(57) ABSTRACT

For deflecting oil, an apparatus includes a shield and a socket interface. The shield has a maximum shield radius in the range of 5.7 to 10 centimeters. The socket interface connects a socket to a turning tool through the shield.

### BACKGROUND

1. Field

The subject matter disclosed herein relates to changing oil and more particularly relates to shielding a user from oil while changing oil.

2. Description of the Related Art

While changing oil, a plug is removed from an oil reservoir, releasing a flow of toxic oil.

### BRIEF SUMMARY

An apparatus for deflecting oil is disclosed. The apparatus includes a shield and a socket interface. The shield has a maximum shield radius in the range of 5.7 to 10 centimeters. The socket interface connects a socket to a turning tool through the shield.

### BRIEF DESCRIPTION OF THE DRAWINGS

A more particular description of the embodiments briefly described above will be rendered by reference to specific embodiments that are illustrated in the appended drawings. Understanding that these drawings depict only some embodiments and are not therefore to be considered to be limiting of scope, the embodiments will be described and explained with additional specificity and detail through the use of the accompanying drawings, in which:

FIG. 1 is a side view drawing illustrating one embodiment of an oil shield apparatus;

FIG. 2 is an isometric drawing view illustrating one embodiment of an alternate embodiment of an oil shield apparatus;

FIG. 3 is an isometric drawing view illustrating one alternate embodiment of an oil shield apparatus;

FIG. 4A is an isometric drawing view illustrating one alternate embodiment of an oil shield apparatus;

FIG. 4B is an isometric drawing view illustrating one alternate embodiment of an oil shield apparatus;

FIG. 5 is an isometric drawing view illustrating an alternate embodiment of an oil shield apparatus;

FIG. 6 is a side view drawing illustrating one alternate embodiment of an oil shield apparatus;

FIG. 7 is a top view drawing illustrating one alternate embodiment of an oil shield apparatus;

FIG. 8 is a top view drawing illustrating one alternate embodiment of an oil shield apparatus;

FIG. 9 is an isometric drawing view illustrating one embodiment of a socket;

FIG. 10 is an isometric drawing view illustrating one embodiment of a ratchet;

FIG. 11 is an isometric drawing view illustrating one embodiment of a T-handle ratchet;

FIG. 12 is an isometric drawing view illustrating one embodiment of a universal joint;

FIG. 13 is a side view drawing illustrating one embodiment of a extension;

FIG. 14 is a side view disassembled drawing illustrating one alternate embodiment an oil shield apparatus;

FIG. 15 is a side view drawing illustrating one embodiment of an oil shield apparatus and a turning tool;

FIG. 16 is an isometric drawing view illustrating an alternate embodiment of an oil shield apparatus and a turning tool;

FIG. 17 is an isometric drawing view illustrating an embodiment of an oil shield apparatus with a drain, a tube, and a turning tool;

FIG. 18 is a side drawing view illustrating an alternate embodiment of an oil shield apparatus, a drain, a tube, and a turning tool;

FIG. 19 is an isometric drawing view illustrating an alternate embodiment of an oil shield apparatus, turning tool, and a drain.

### DETAILED DESCRIPTION

Reference throughout this specification to “one embodiment,” “an embodiment,” or similar language means that a particular feature, structure, or characteristic described in connection with the embodiment is included in at least one embodiment. Thus, appearances of the phrases “in one embodiment,” “in an embodiment,” and similar language throughout this specification may, but do not necessarily, all refer to the same embodiment, but mean “one or more but not all embodiments” unless expressly specified otherwise. The terms “including,” “comprising,” “having,” and variations thereof mean “including but not limited to” unless expressly specified otherwise. An enumerated listing of items does not imply that any or all of the items are mutually exclusive and/or mutually inclusive, unless expressly specified otherwise. The terms “a,” “an,” and “the” also refer to “one or more” unless expressly specified otherwise.

Furthermore, the described features, advantages, and characteristics of the embodiments may be combined in any suitable manner. One skilled in the relevant art will recognize that the embodiments may be practiced without one or more of the specific features or advantages of a particular embodiment. In other instances, additional features and advantages may be recognized in certain embodiments that may not be present in all embodiments.

The description of elements in each figure may refer to elements of proceeding figures. Like numbers refer to like elements in all figures, including alternate embodiments of like elements.

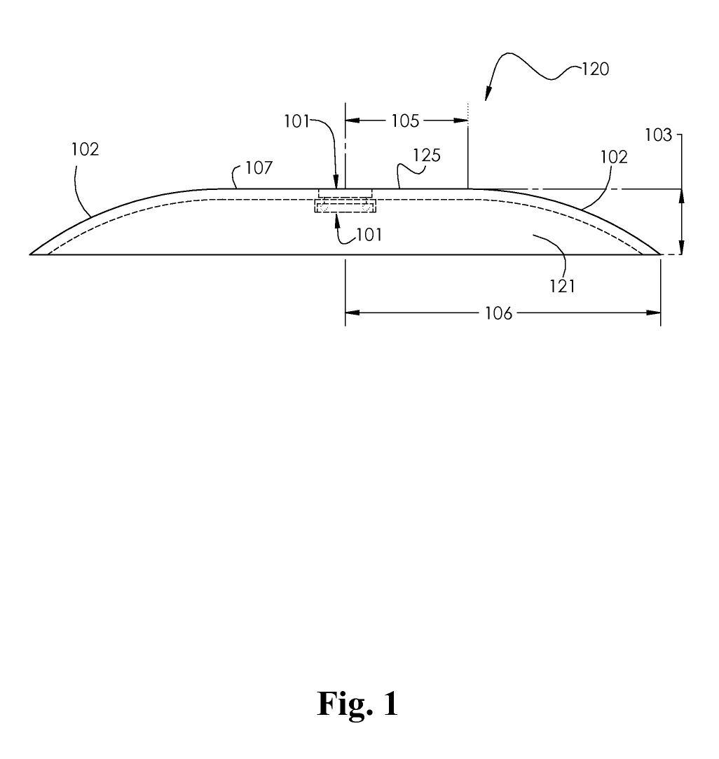

FIG. 1 is a side view drawing illustrating one embodiment of an oil shield apparatus 120. The oil shield apparatus 120 deflects toxic oil from a user during an oil change. The oil shield apparatus 120 includes a shield 121 with a socket interface 101. The apparatus 120 allows a turning tool system such as a ratchet, a t-handle ratchet, a universal joint, and/or an extension to rotate a socket to unfasten an oil plug while shielding the user. The socket interface 101 connects a socket to a turning tool system through the shield 121. When a user removes a plug from an oil reservoir while changing oil, toxic oil streams from the oil reservoir and may contact the user. The turning tool system connects a socket to a plug in a reservoir and rotates to urge a plug to release the toxic oil. The oil shield apparatus 120 shields the user from the toxic oil while allowing the user to access the plug with a socket which may be magnetized.

The shield 121 and socket interface 101 may be a solid body. The shield 121 may be convex, concave, or a combination of convex and concave bends and curves. The shield 121 may have a maximum shield radius in the range of 5.7 to 10 centimeters (cm). The shield 121 may include a planar base 107 and a lip 102. The shield 121 may also comprise the socket interface 101 that connects a socket to a turning tool system through the shield 121.

The planar base 107 may be flat. The planar base 107 may have a deviation from the planar surface of the planar base 107 of less than 10 percent. The planar base 107 may provide clearance for the turning tool system passing through the socket interface 101 to rotate clear of the shield 121. In one embodiment, the planar base 107 is made of rigid material. Alternatively, the planar base 107 may be made of a flexible material. The planar base 107 may have a maximum radius in the range of 1.5 to 1.6 cm. Alternatively, the planar base 107 may have a maximum radius 105 in the range of 1.9 to 2.54 cm. The planar base may be made of a rubber-like membrane 125.

The lip 102 may be concave to the socket 109. Alternatively, the lip 102 may be concave, convex, bent angle including bent multiple angles, or combinations thereof. The lip 102 may incorporate triangular angled sections that collapse and expand as an umbrella and have a water and/or oil resistant rubber membrane. The height 103 of the lip 102 from the planar base 107 is in the range 105 of 1.5 to 1.6 cm. The lip 102 may further deflect the oil from the user.

The socket interface 101 allows the turning tool system to rotate a socket through the shield 121. The socket interface 101 may be an orifice in the shield 121. Alternatively, the socket interface 101 may be separate from and rotate within the shield 121. In one embodiment, the socket interface 101 is magnetized.

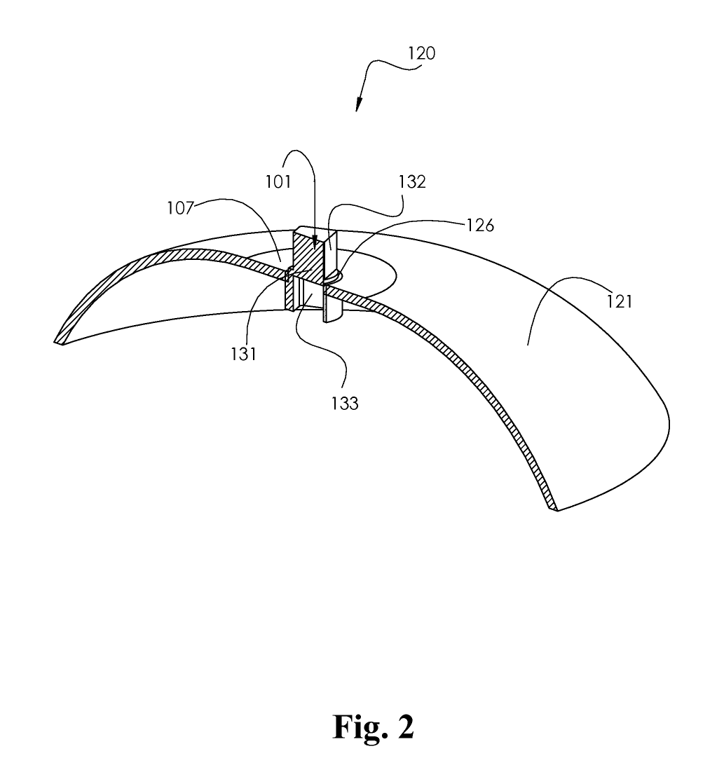

FIG. 2 shows an isometric view of one embodiment of an oil shield apparatus 120. The oil shield apparatus 120 may not include a seal. The socket interface 101 may include a rotating lug 131. In one embodiment a planar base 107 provides clearance for the rotating lug system 131. The socket interface 101 may be a welded solid body 126 with the rotating lug 131. The shield 121, planar base 107, the socket interface 101 and lug system 131 may be a welded solid body 126.

The apparatus 120 may include a formed filled molded socket interface 101 and a form fill molded lugged extension which may be part of a solid body 126. The oil shield apparatus 120 may be molded and couple the lug system 131. The lug system 131 may include an outer lug 132 and an inner lug 133. The oil shield apparatus 120 may be coupled with a turning tool system such as a ratchet and a socket to drain the toxic oil outwardly from a reservoir by rotating the drain plug and diverting the oil from the user. The shield apparatus 120 may be made from polymer fill formed plastic injection mold, machined from billet of a metallic element, or formed as a metallic or non-metallic casting.

In one embodiment the shield 121 and lug system 131 may be fabricated from a suitable and durable such as material polycarbonate, combined with metallic elements or fabricated with magnetic inserts. Alternatively, the shield 121 may be fabricated from the group consisting of a stamped metal, carbon fiber epoxy resin and a molded plastic; including nickel and carbon alloy steels, zinc and copper elements, and polymer, nylon and polytetrafluoroethylene plastics. In one embodiment the shield 121 may be transparent or opaque.

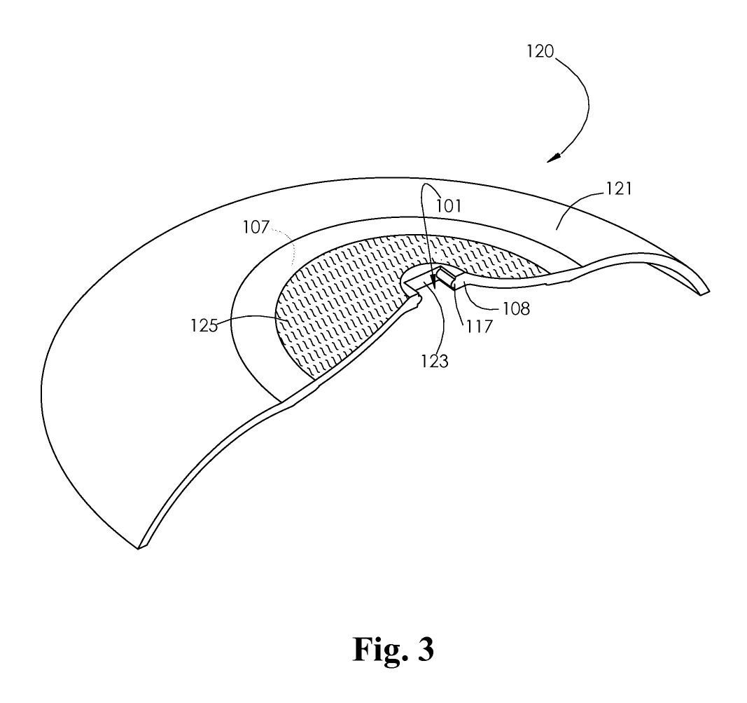

FIG. 3 shows an isometric view of one embodiment of an oil shield apparatus 120. The socket interface 101 may include a square orifice 123. The square orifice 123 may have a side length in the range of 1 to 3 cm.

In the depicted embodiment, the socket interface 101 may include a square orifice 123 with a seal 108. The seal 108 may be elastic. The seal 108, the square orifice 123, and the socket interface 101 may further expand upon entry of the turning tool system. The seal 108 may include an oil barrier O ring 117. The orifice 123 may prevent toxic oil from traversing down the turning tool system to contaminate a user. The socket interface 101 and an elastic membrane 125 may be oil and water resistant. The elastic membrane 125 may have a stretchable socket interface 101.

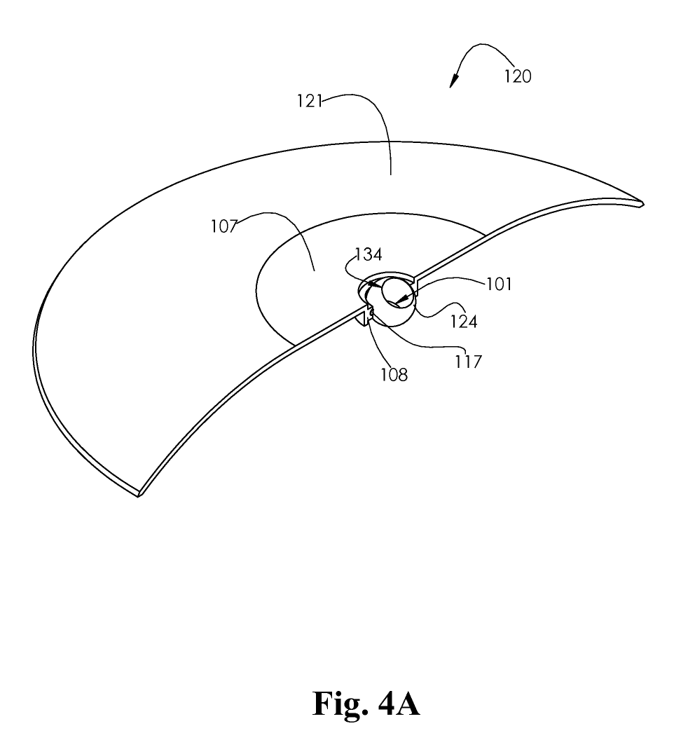

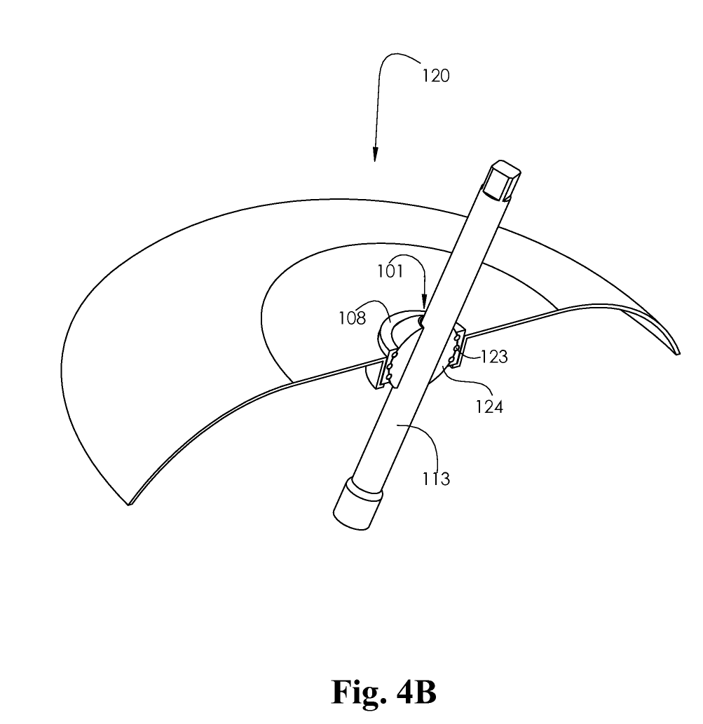

FIG. 4A shows an isometric view of one embodiment of an oil shield apparatus 120. The socket interface 101 may include a seal 108, a pivot bearing 124 and an annular orifice 134. In the depicted embodiment, the annular orifice 134 may pivot about the pivot bearing 124. The seal 108 may also be included about the pivot bearing 124. The pivoting socket interface 101 may provide directional positioning when diverting the toxic oil. The pivot bearing 124 may have an orbital coordinate three axis range of locating a socket. The pivot spherical bearing 124 may position a socket 109 in a 3 axis range 45 degrees to 135 degrees from a starting position perpendicular to the planar base 107.

An oil barrier O ring 117 may be incorporated in the seal 108 to prevent cracking when a turning tool system enters the socket interface 101. The oil barrier O ring 117 may provide a second layer of protection between the toxic oil and the user. In the depicted embodiment, the oil barrier O ring 117 may have a fillet radius formed from an element of an elastic material or rubber. The O ring 117 may prevent cracking of the elastic material by the radius fillets from which it may be formed.

FIG. 4B shows an isometric view of one embodiment of an oil shield apparatus 120. In the depicted embodiment, the socket interface 101 may incorporate a seal 108 with a bearing 123 and a pivot bearing 124. The spherical pivot bearing 124 articulates with degrees of freedom through an orbital range about the bearing 123 where the limits may be by interference contact with the bearing 123. The bearing 123 may be sealed. The bearing 123 may provide a user increased toxic oil protection. The oil seal 108 may prevent oil penetration through the socket interface 101 when an extension 113 is introduced in the socket interface 101. The sealed bearing 123 may have an interference slip fit with the turning tool system 114.

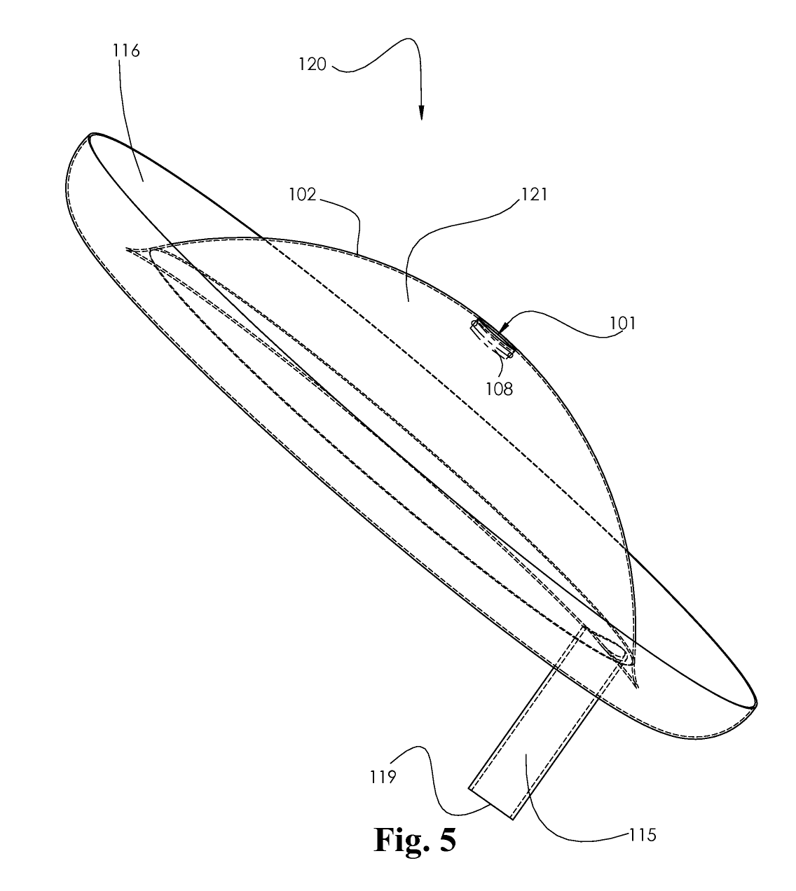

FIG. 5 shows an isometric view one embodiment of an oil shield apparatus 120. The shield 121 includes a concave lip 102, a convex rim 116, a socket interface 101, a seal 108, and a flume 115. The flume 115 can be a closed tube or open channel. The flume drain 119 may protect the user from the outward flow of toxic oil.

Alternatively, the oil shield apparatus 120 may comprise a diversion channel selected from the group consisting of a groove, a flume, flashing, corrugation and a deflecting shield. In the depicted embodiment, the socket interface 101 includes a seal 108 that forms a seal with the socket and/or the turning tool system.

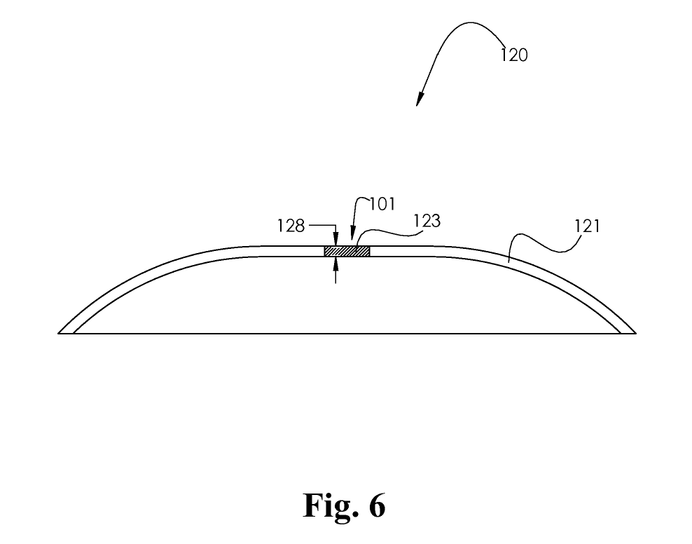

FIG. 6 is a side view shows one embodiment of the oil shield apparatus 120. In the depicted embodiment, the socket interface 101 may comprise an orifice 123 centered within the planar base 107. The socket interface 101 may have a thickness 128 in the range of 0.5 millimeters to 8 millimeters (mm).

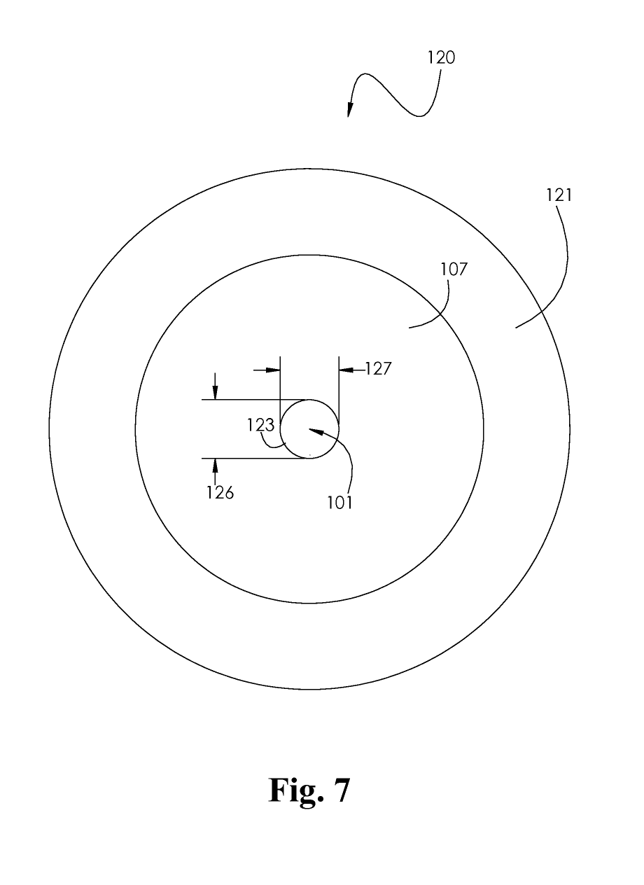

FIG. 7 a top view shows one embodiment of the oil shield apparatus 120. The apparatus 120 includes the oil shield 121, the planar base 107, and the socket interface 101. The socket interface 101 may be a circle orifice 123 or an ellipse orifice 123, or other similar shapes of an orifice 123. The orifice 123 may have a first orifice diameter 126 in the range of 1 to 3 cm and/or a second orifice diameter 127 in the range of 1 to 3 cm. The orifice 123 for the socket interface 101 may be have an orifice gauge 128 in the range of 4 mm to 40 mm. Alternatively, the orifice may have an orifice gauge 128 in the range of 5 mm to 45 mm.

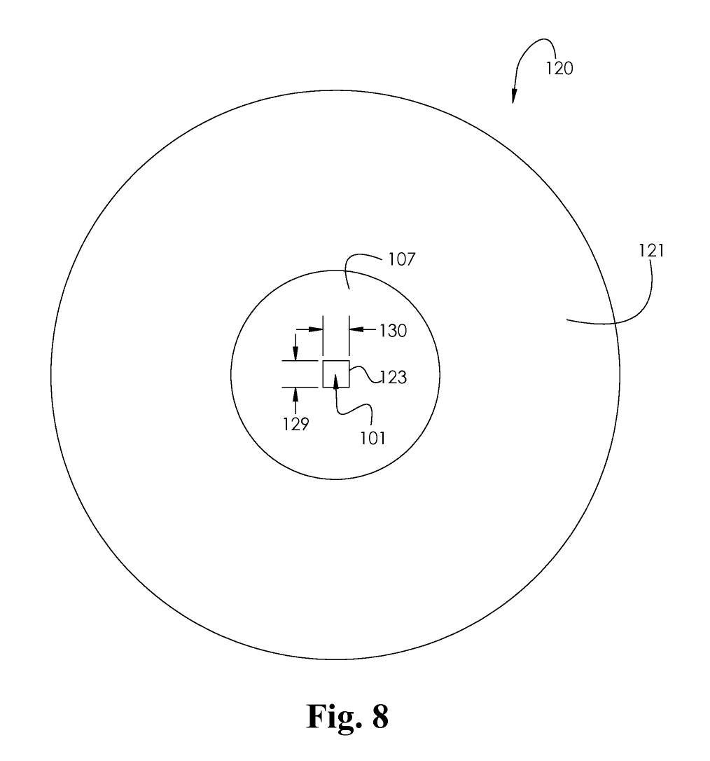

FIG. 8 a top view shows one embodiment of the oil shield apparatus 120. The apparatus 120 includes an oil shield 121 and a socket interface 101 with an orifice 123. The square orifice 123 may be embedded in the planar base 107 and/or the socket interface 101. The orifice 123 may be a square, hexagonal, or rectangle, or other similar shape. The orifice 123 may have a side length 129, 130 in the range of 1 to 3 cm. The orifice 123 of the socket interface 101 may have a thickness 128 in the range of 4 mm to 40 mm and may have an elongated thickness 128 in the range of 5 millimeters to 45 mm.

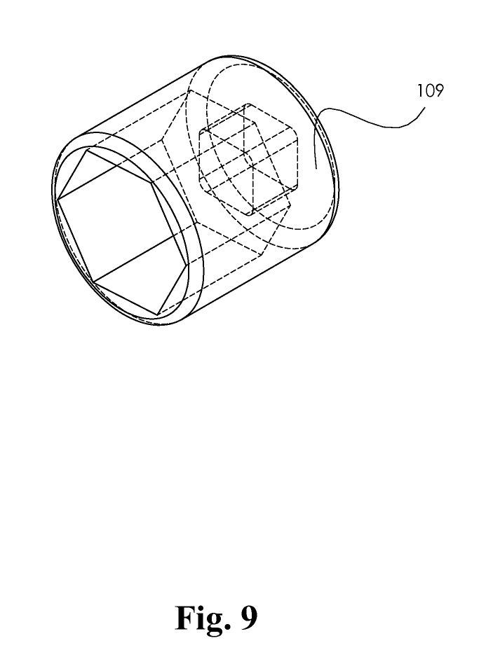

FIG. 9 is an isometric view of a socket 109 used to urge a plug from a reservoir. The socket 109 maybe magnetized. Alternatively, the socket 109 may include an instrument which may engage a fastener such as an Allen head fastener, a torx fastener, Phillips head fastener, and other various types of connections between a tool and a fastener head. The socket 109 is designed to rotate the plug enabling the user to urge the plug from a reservoir. The socket 109 may be coupled with a ratchet 110, extension 113, universal joint 112 and/or T-handle 111. The ratchet, extension, universal joint, T-handle or the like is referred to as a turning tool system.

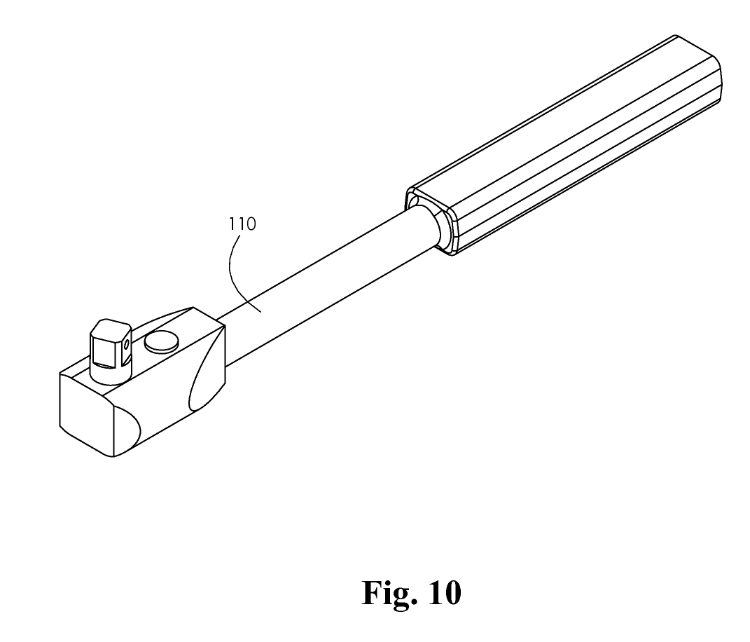

FIG. 10 is an isometric drawing view one embodiment of a ratchet 110. The ratchet 110 may be the turning tool system.

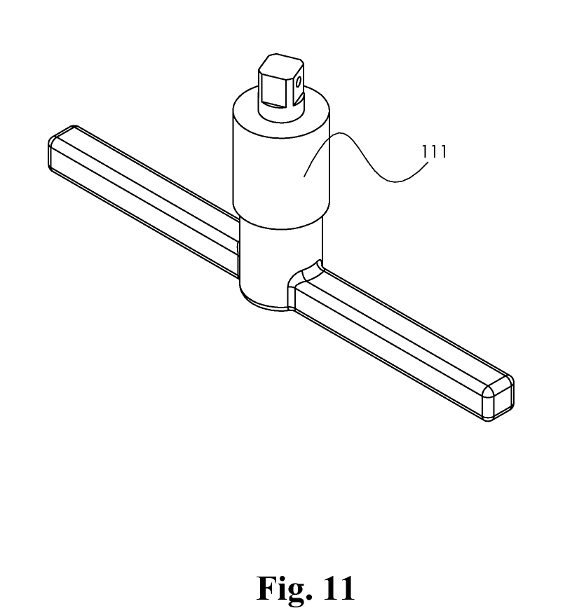

FIG. 11 is isometric drawing view one embodiment of a T-handle ratchet 111. The T-handle ratchet 111 may be the turning tool system.

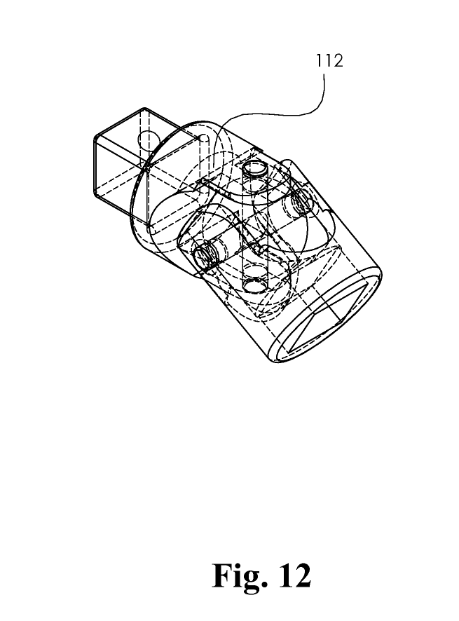

FIG. 12 is an isometric drawing view one embodiment of a universal joint 112. The universal joint 112 may be coupled with a turning tool system to enable an orbital axis of rotation. The universal joint 112 may pivot in the range of 45 degrees to 135 degrees.

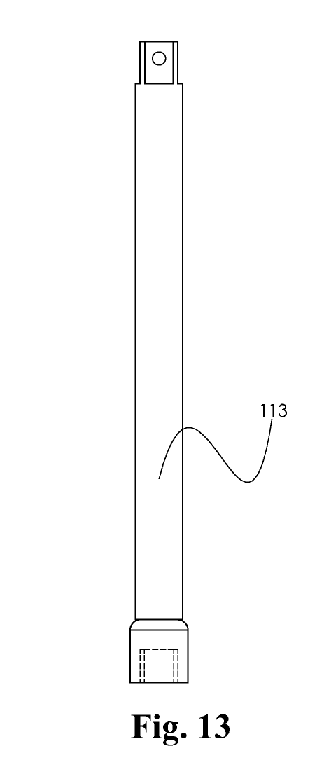

FIG. 13 is a side view drawing one embodiment of an extension 113. The extension 113 may be added or removed used to change the distance between the turning tool system and a socket 109.

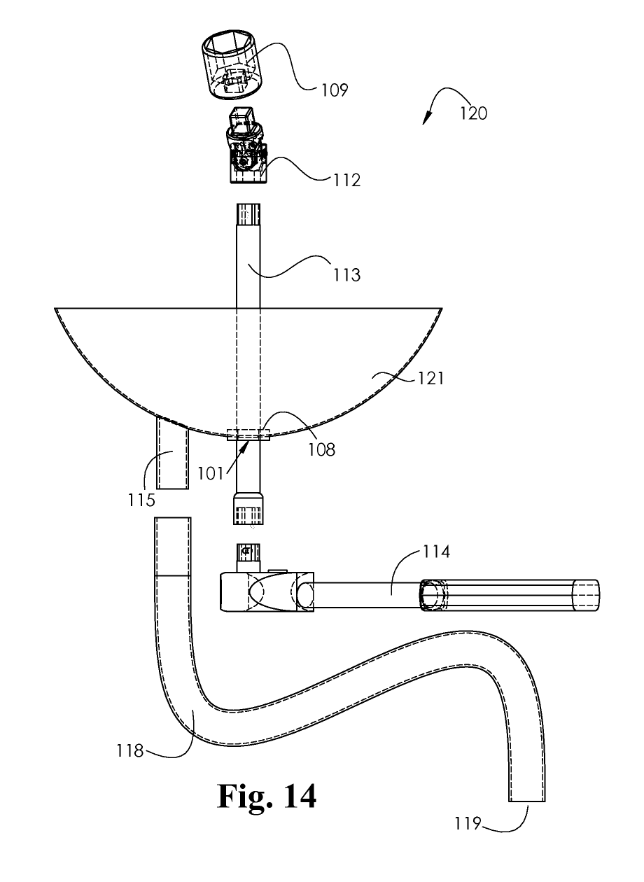

FIG. 14 is a side exploded view drawing of one embodiment of an oil shield apparatus 120. The apparatus 120 includes an uncoupled turning tool system 114, an uncoupled extension 113 inserted through the socket interface 101, a convex shield 121, a flume 115, an uncoupled tube 118, a seal 108, an uncoupled universal joint 112, and a uncoupled socket 109. The tube 118 may divert oil from the shield 121. The flume 115 may be fixed and/or flexibly coupled to the tubing 118. Toxic oil may flow outwardly in the convex shield 121, outwardly to the flume 115, traverse the inner tubing 118, and exit a drain orifice 119.

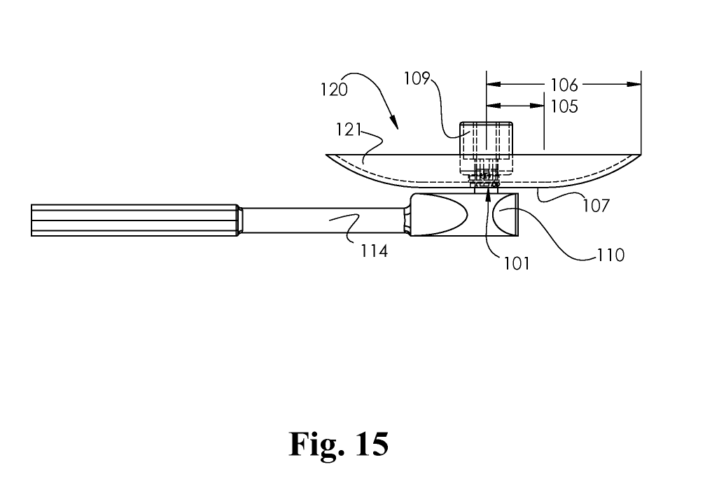

FIG. 15 is an isometric drawing view of a multiple embodiment of an oil shield apparatus 120. The turning tool system 114, the socket interface 101, the seal 108 and the oil shield 121 are shown. The planar base 107 may have a planar base radius 105 in the range of 1.5 to 1.6 cm. The shield 121 may have a shield radius 106 in the range of 5.7 to 10 cm. The shield 121 is convex to the socket 109. The turning tool system 114 includes of a ratchet 110 and a socket 109.

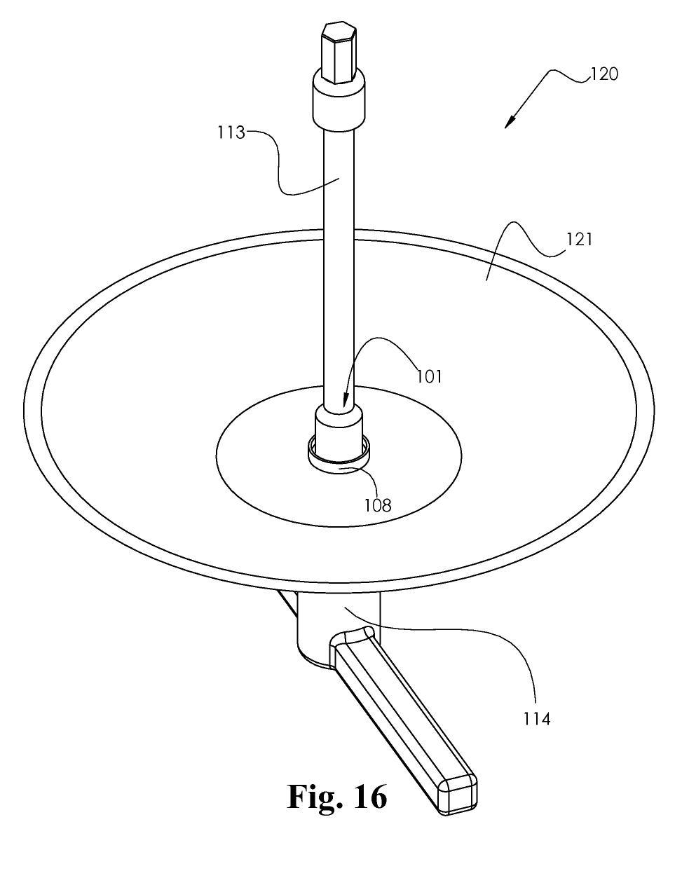

FIG. 16 is an isometric drawing view of an embodiment of an oil shield apparatus 120. The turning tool system 114, the shield 121, the extension 113, and the socket 109 are shown. The shield 121 is convex to the socket 109 and the extension 113 and the turning tool system 114 is protruding through the socket interface 101 and seal 108.

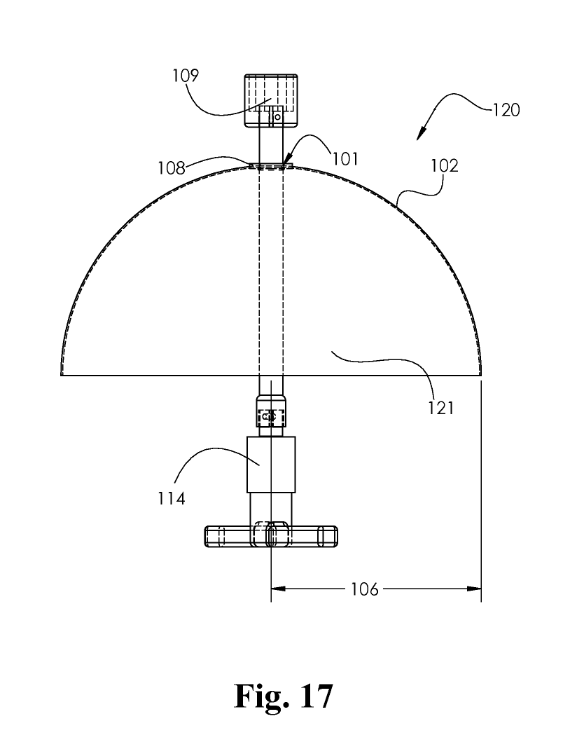

FIG. 17 is an isometric drawing view of one embodiment of an oil shield apparatus 120. The shield 121, the lip 102, the turning tool system 114, the seal 108, and the socket 109. The shield 121 may be convex to the socket 109 and concave to the turning tool system 114. The shield 121 further diverts the oil over the lip 102. The socket interface 101 and seal 108 allow the turning tool system 114 to remove an oil plug while protecting the user.

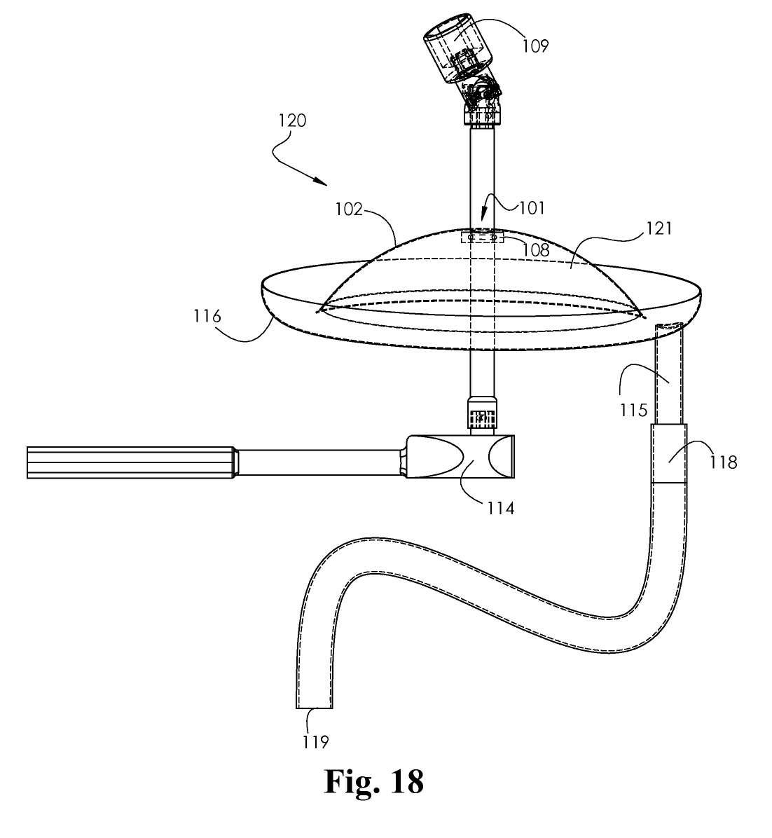

FIG. 18 is a side drawing view one embodiment of an oil shield apparatus 120. The shield 121 diverts the oil over a concave lip 102 and a convex rim 116 to a drain flume 115. The drain orifice 119 provides a more precise destination for directing the toxic oil away from the user. The oil shield apparatus 120 further diverts the oil over the lip 102 to the flume 115. The turning tool system 114 protrudes through the socket interface 101. The seal 108 may be disposed on the socket interface 101 and form a seal 108 between the socket interface 101 and the socket 109 to provide added protection.

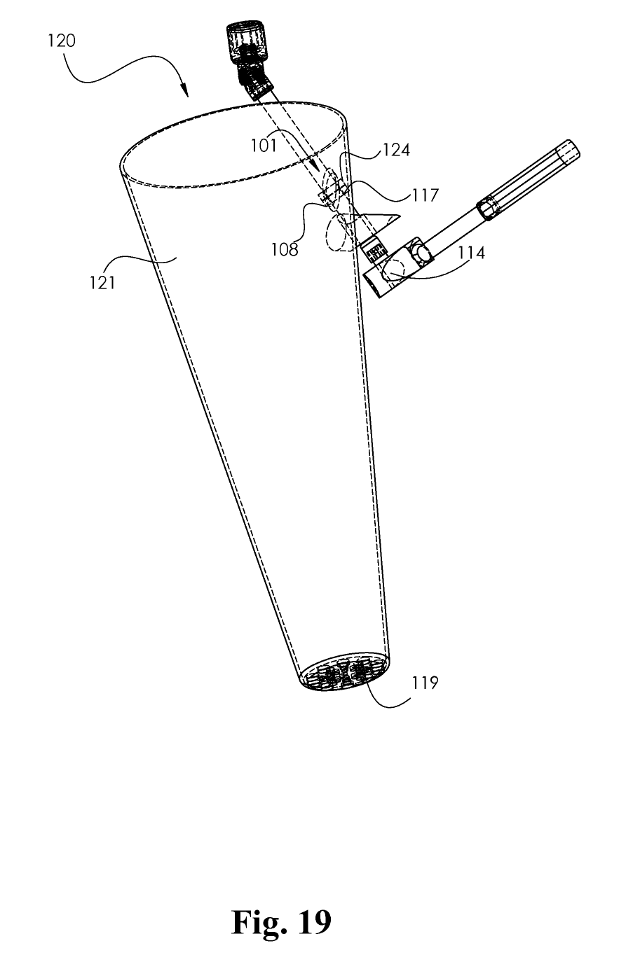

FIG. 19 a side view of one embodiment of an oil shield apparatus 120 wherein the shield 121 may be a cone or funnel. The shield 121 funnels the oil to a drain orifice 119. The turning tool system 114 may be coupled by one or more fastening points which may include an elongated seal 108, a pivot bearing 124 and an O ring 117. The shield 121 may have a cone shape.

The embodiments include a socket interface 101 that allows a user to remove the plug with a socket 109 and turning tool system 114 while protected behind the shield 121. As a result, the user is protected from toxic oil.

Embodiments may be practiced in other specific forms. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. An apparatus comprising:
a shield having a maximum shield radius in the range of 5.7 to 10 centimeters (cm); and
a socket interface that connects a socket to a turning tool through the shield. a user connects a socket to a plug in a reservoir and rotates to urge a plug to release the toxic oil.

2. The apparatus of claim 1, wherein the socket interface has a thickness in the range of 0.5 millimeters to 8 millimeters (mm).

3. The apparatus of claim 1, wherein the socket interface comprises a square orifice with a side length in the range of 1 to 3 cm.

4. The apparatus of claim 1, wherein the shield comprises planar base with a maximum radius in the range of 1.5 to 1.6 cm.

5. The apparatus of claim 4, wherein the shield comprises a lip concave to the socket.

6. The apparatus of claim 5, wherein the height of the lip from the planar base is in the range of 1.5 to 1.6 cm.

7. The apparatus of claim 1, the apparatus further comprising a drain flume.

8. The apparatus of claim 1, wherein the shield is formed of a material selected from the group consisting of a stamped metal, carbon fiber epoxy resin and a molded plastic including nickel and carbon alloy steels, zinc and copper elements, and polymer, nylon and polytetrafluoroethylene plastics.

9. The apparatus of claim 1, wherein the socket tool is selected from the group consisting of a socket wrench, an adjoining extension, a universal joint and a socket.

10. The apparatus of claim 1, the apparatus further comprising a seal disposed on the socket interface and forming a seal between the socket interface and the socket.

11. The apparatus of claim 1, the apparatus further comprising a diversion channel selected from the group consisting of a groove, a flume, flashing, corrugation and a deflecting shield.

12. The apparatus of claim 1, wherein the socket interface is magnetized.

13. A method for shield module comprising:
providing a shield having a maximum radius in the range of 5.7 to 10 centimeters (cm); and
providing a socket interface that connects a socket to a socket tool through the shield.

14. The method of claim 13, wherein the method further comprises diverting oil from a drain with the shield.
